(19) United States
(12) Patent Application Publication
(10) Pub. No.: US 2013/0104337 A1
(43) Pub. Date: May 2, 2013

(54) Port-A-Plow storage caster device for snowplows

(71) Applicants: Donald V. Nabb, Alexandria, IN (US); Susan Nabb, Alexandria, IN (US)

(72) Inventors: Donald V. Nabb, Alexandria, IN (US); Susan Nabb, Alexandria, IN (US)

(73) Assignee: Metal Craft, LLC, Alexandria, IN (US)

(21) Appl. No.: 13/651,432

(22) Filed: Oct. 14, 2012

Related U.S. Application Data
(60) Provisional application No. 61/551,607, filed on Oct. 26, 2011.

(51) Int. Cl. B60B 33/00

(52) U.S. Cl. 16/30

(57) ABSTRACT

Disclosed is a new lightweight snowplow dolly device for aiding in removing and attaching a lightweight pickup truck-type snowplow blade assembly and also moving and storing the removed blade assembly. The lightweight snowplow device comprises a set of three or more caster wheels with vertical shafts and a means to removably secure the casters to the snowplow.

### CROSS-REFERENCE TO RELATED APPLICATIONS

Not Applicable

This application claims the benefit of Provisional Patent Application Ser. No. 61/551,607 filed Oct. 26, 2011 by Donald V. and Susan Nabb and entitled “Port-A-Plow storage caster device for snowplows”.

### FIELD OF INVENTION

The invention relates generally to the field of snow plow carts and dollies. More specifically, the invention is directed to an improved snow plow mover device employing a simple yet sturdy set of caster devices that securely retains a snow plow thereon.

### FEDERALLY SPONSORED RESEARCH

None.

### SEQUENCE LISTING OR PROGRAM

None.

### BACKGROUND

### Field of Invention and Prior Art

Problems Addressed:

Snow plow dollies with extensive structures and complex attachments are well known in the art. Many disclose an integral support frame for supporting the snow plow blade and jack, and a positioning means—typically wheels or casters—for maneuvering the snow plow blade once it has been placed on the dolly mechanism and detached from the carrying vehicle. Several also disclose adjustment means for accommodating different height snow plow jacks.

As will be seen by viewing prior art, most of the disclosed devices comprise complicated mechanisms for adjusting the height of the snow plow supports. Most position the wheels or casters directly beneath the frame. None of the prior art discloses a simple, inexpensive snow plow dolly having a low center of gravity for stability with multiple devices for securing a snow plow thereon without risk of front or lateral slippage during movement.

Conventional snow blade mounts for four wheel drive vehicles such as pick-up trucks can weigh several hundred pounds, and generally include a chassis frame that can be permanently fixed to the vehicle chassis, usually behind the vehicle front bumper. A lift frame is then removably coupled to the chassis frame, and the snow blade is then coupled to the front end of the assembly via an A-frame and trip frame assembly. The A-frame with the snow blade attached is typically removable from the vehicle. Conventionally, the lift frame has been permanently mounted to the chassis frame (and therefore not readily removable from the vehicle), and the hydraulic pump used to operate the snow blade was located under the vehicle hood, and were driven using a belt drive driven by the vehicle engine. However, safety considerations now often dictate that the lift frame be removed when the plow is not in use.

One drawback of conventional snow blade mounts is the difficulty in readily attaching and removing the lift frame assemblies from the vehicle chassis, especially in view of their weight.

The business of manufacturing snow plows for light and medium duty trucks has been highly competitive, with manufacturers of competing snow plows differentiating themselves based on the features and enhanced technology that they design into their products. Two types of features that are particularly important are the ease of installation (and removal) and features bringing an enhanced level of performance in plowing snow. The Port-A-Plow casters clearly address the ease of installation.

In the past several years one of the most important of these features has been the ease of installation of a snow plow. While the first snow plows were bolted onto supports which were typically welded onto the frame of a truck at the front end thereof, it will be appreciated by those skilled in the art that such an installation mechanism makes the installation both difficult and time consuming. Since snow plows for light and medium duty trucks weigh hundreds of pounds and are somewhat unwieldy, merely getting the snow plow into the proper position for installation can be a problem. In addition, bolting the snow plow onto the supports can also be difficult to accomplish. Even when it is straightforward, it is time consuming and awkward, particularly when done during the winter when the weather is cold.

Thus, it is apparent that one of the most important improvements which can be made to the design of a mechanism for a snow plow for mounting the snow plow on a truck which improves the snow plow installation process. A number of attempts at designing such mechanisms have been made, but they have all been of a less than optimal design. One problem is that many such hitch mechanisms require such a precise degree of accuracy in the interconnection of the snow plow-mounted hardware and the truck-mounted hardware that they are difficult and time consuming to install.

Another problem is that some previously known hitch mechanisms are unduly complex, both in construction and in operation, which means that they are both expensive to manufacture and difficult to operate. Still another problem with some existing hitch mechanisms is that they provide a less than secure and robust connection between the snow plow and the truck. Yet another problem with them is that many of them have mechanisms which are bulky, reducing the ground clearance between the bottom of the hitch mechanisms and the ground significantly.

Prior Art:

One drawback of conventional snow blade mounts is the difficulty in readily attaching and removing the lift frame assemblies from the vehicle chassis, especially in view of their weight. To that end, U.S. Pat. No. 5,125,174 issued to Watson, et al in 1992 and entitled “Removable snowflow with a pivotable lift stand” discloses a removable snowplow including a removable lift frame and A-frame combination. However, the lift frame assembly is permanently mounted to the A-frame, thus requiring removal of both simultaneously, as a unit. U.S. Pat. No. 5,353,530 issued in 1994 to Pieper entitled “Quick mounting snow plow assembly” is of a similar vein. Nabb does not have these limitations. The Port-A-Plow mounts easily to the existing plow frame.

The Internet also discloses several snow plow dollies having similar features as the patented devices described above. “Quickmount”, at http://www.quickmountplowcart.com (Feb. 17, 2006), discloses a T-shaped snow plow dolly with an integrated jack lift. There are no integral jacks with the Port-A-Plow. “Snow Plow Carts”, at http://www.4gte.com/snowplow_carts.html (Feb. 17, 2006), discloses an H-shaped snow plow dolly having lateral channels to retain the snow plow blade and the snow plow jack. Wheels for positioning the device are located directly beneath the frame. Here the costly frame is added and redundant when compared to the Nabb Port-A-Plow.

“The Plow Buddy”, at http://www.assoc-elec-prod.com/PBBenefits.htm (Feb. 17, 2006), discloses a T-shaped snow plow dolly having an integral scissor jack for adjusting the height of the snow plow jack. It uses outriggers to raise the wheels and thus lower the frame, but has no lateral or front members to prevent slippage of the snow plow blade or snow plow jack. Again more complex and costly with redundant framing structures compared to the Nabb device.

U.S. Pat. No. 4,821,435 issued in 1989 to Pester and entitled “Snow plow alignment and storage system” describes a snow plow alignment and storage system having a wheeled carrier with a frame supported on caster wheels. The invention disclosed has a disadvantage in that its small size may make it unstable when handling wide and heavy plow assemblies. The prior art also discloses wheeled carrier for a snow plow as shown in U.S. Pat. No. 4,887,838 to Reppen issued in 1989, a snow plow dolly in U.S. Pat. No. 4,572,531 issued in 1986 to Elia, and a plow dolly of U.S. Pat. No. 3,941,400 issued in 1976 to Buttner. All three of these devices may be difficult to operate because of inadequate or nonexistent plow blade guide/stop members.

Another relevant patent is U.S. Pat. No. 5,050,898 issued in 1991 to Petrell, Jr. and entitled “Mobile platform for a snow plow” discloses a mobile platform for a snow plow. While this device fulfills its particular objectives and requirements, the aforementioned patent discloses a rather complex apparatus having a high cost to produce and market.

As now explained describing the problems addressed and the relationships with prior art and as far as known, there are no Port-A-Plow caster devices to facilitate plow installation and storage or the like. It is believed that this product is unique in its design and technologies.

### SUMMARY OF THE INVENTION

This invention is a Port-A-Plow caster device to facilitate plow installation and storage. Taught here are the ways a device to store and move snow plows may be placed safely and securely onto a plow of a light and medium duty truck. This may be as an original equipment option with the snowplows at initial sale or an add-on system sold in the equipment aftermarket.

The preferred embodiment of the Port-A-Plow caster device is comprised of a set of at least three special and durable casters each with a vertical shaft and other distinct features; and a means to removably secure each of the casters to the snowplow. The device wheels may be of durable plastic, urethane, neoprene or other composite materials, metal, steel, cast iron, steel allow, aluminum and the like. The rest of the structure is of metal or high durability composite materials.

The newly invented Port-A-Plow caster device may be manufactured at low volumes by very simple means and in high volume production by more complex and controlled systems.

### OBJECTS AND ADVANTAGES

There are several objects and advantages of the Port-A-Plow caster device to facilitate plow installation and storage. There are currently no known dollies or carts for storing snowplows that are effective at providing the objects of this invention. The Port-A-Plow caster devices expect to meet several immediate objectives. The general purpose of the present invention, which will be described subsequently in greater detail, is to provide a new lightweight snowplow dolly apparatus and method which has all the advantages of the prior art snowplows and none of the disadvantages.

These include:

| Item | Objective |
|---|---|
| 1 | Provides a lightweight snowplow dolly to be quickly |
| | and easily assembled, dis-assembled, lifted and |
| | moved by an average individual. |
| 2 | May be attached to most snowplows without welding or |
| | significant metal fabricating |
| 3 | Provides a snow blade mount and lift assembly for a |
| | vehicle that is easily attachable and removable from |
| | the vehicle |
| 4 | Is durable and reliable |
| 5 | Is a safe and secure means to move a snowplow |
| 6 | Provides a compact, lightweight and portable device |
| 7 | Provides a low cost, easy to manufacture snow plow |
| | dolly having a low center of gravity |
| 8 | May be Marketed to professional snow removers for |
| | easy installation and storage of snow plows. |
| 9 | Has Economical pricing for independent snow removal |
| | persons |
| 10 | May use existing process and manufacturing equipment |
| | so that there are relatively low start-up costs to manufacture |
| 11 | Has a good cost to price ratio for business sensibility |
| 12 | Can be sold retail or wholesale |
| 13 | May be sold via internet sales |

### DESCRIPTION OF THE DRAWINGS

### Figures

The accompanying drawings, which are incorporated in and constitute a part of this specification, illustrate an embodiment of the Port-A-Plow caster device that is preferred. The drawings together with the summary description given above and a detailed description given below serve to explain the principles of the snowplow storage device. It is understood, however, that the Port-A-Plow caster device is not limited to only the precise arrangements and instrumentalities shown.

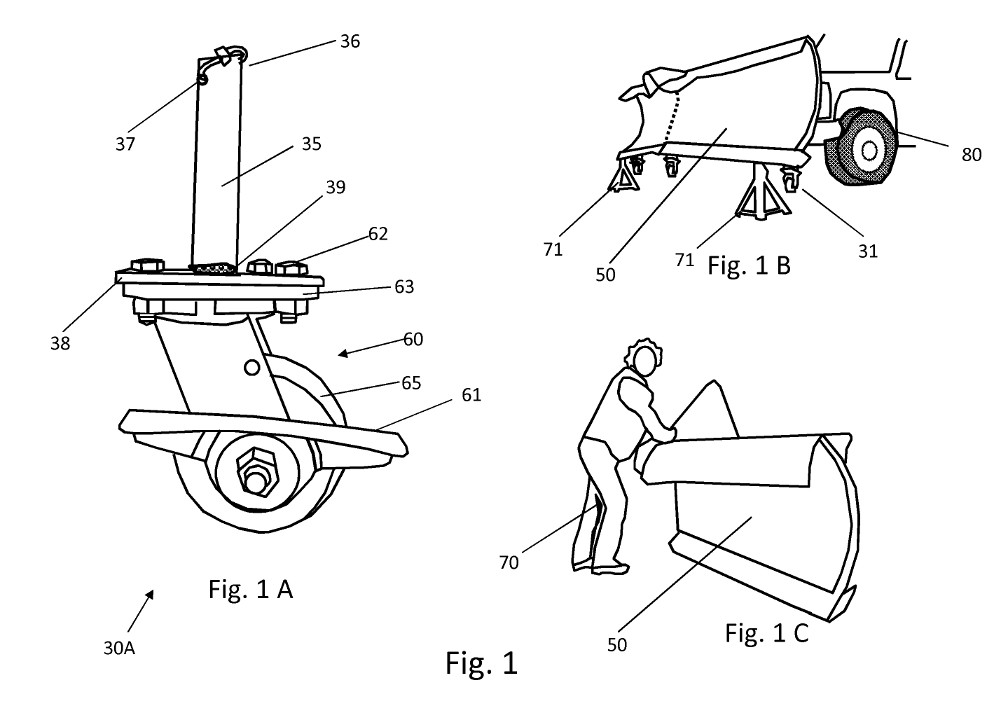

FIGS. 1A through 1 C are sketches of the Port-A-Plow caster; installation on the plow blade and general moving of the blade on the casters.

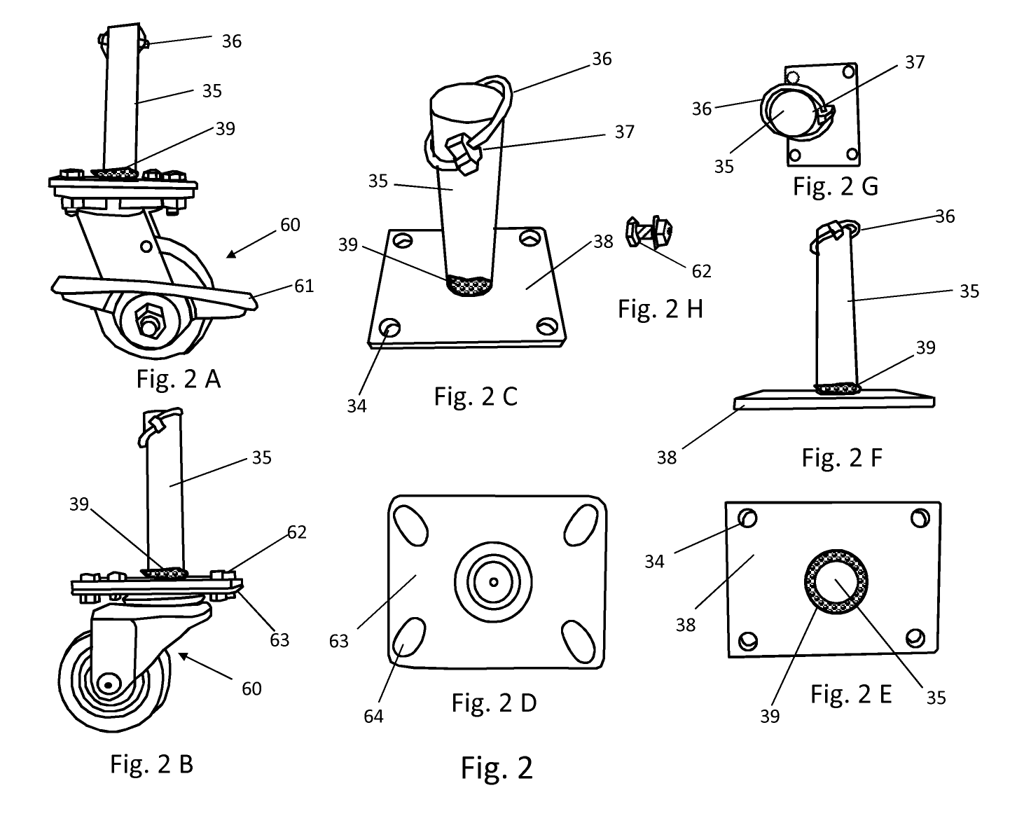

FIGS. 2 A through 2 H are sketches of the Port-A-Plow caster device with components and features noted.

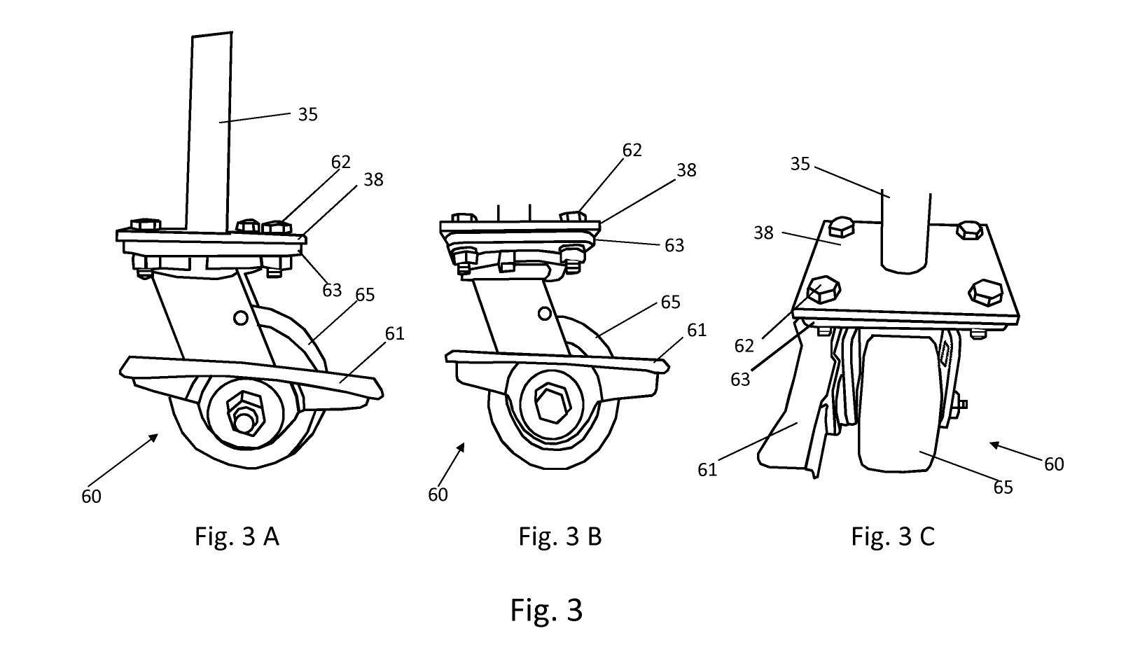

FIGS. 3 A through 3 C are sketches of a prototype sample of the Port-A-Plow caster with the components and features shown from generally a side and end view.

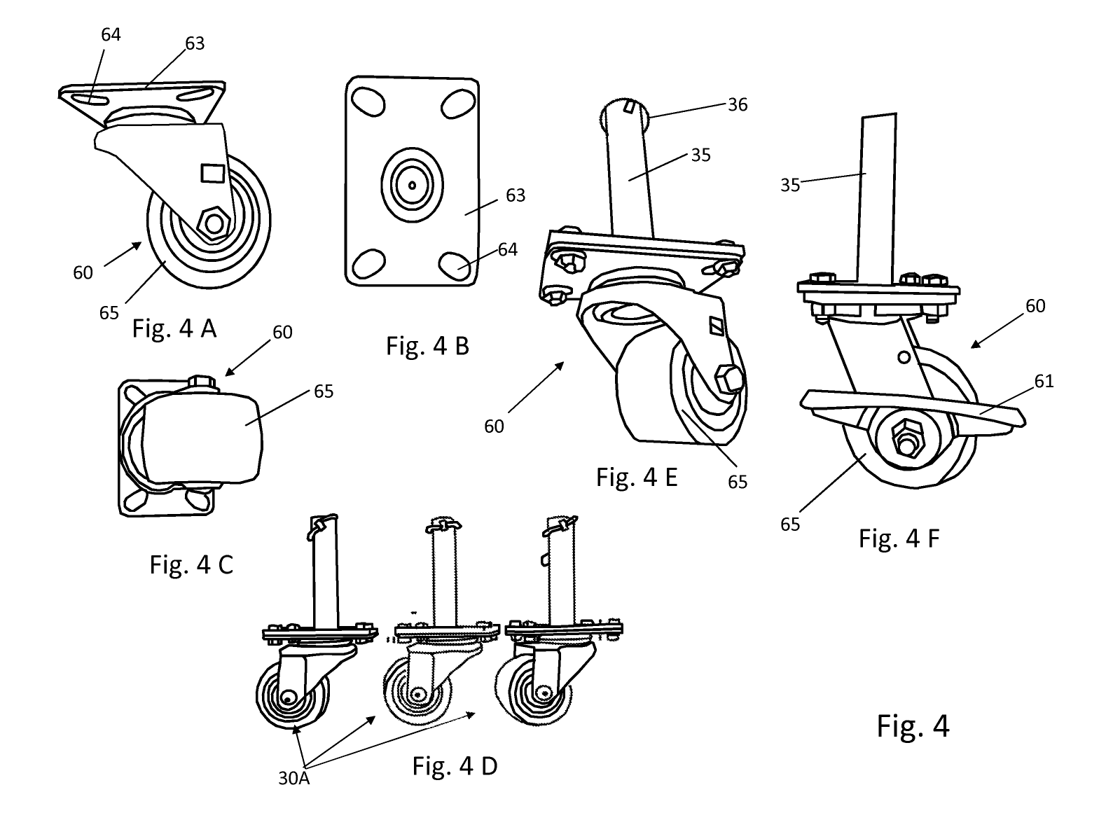

FIGS. 4 A through 4 F are more sketches of a prototype sample of the Port-A-Plow caster and components from various views.

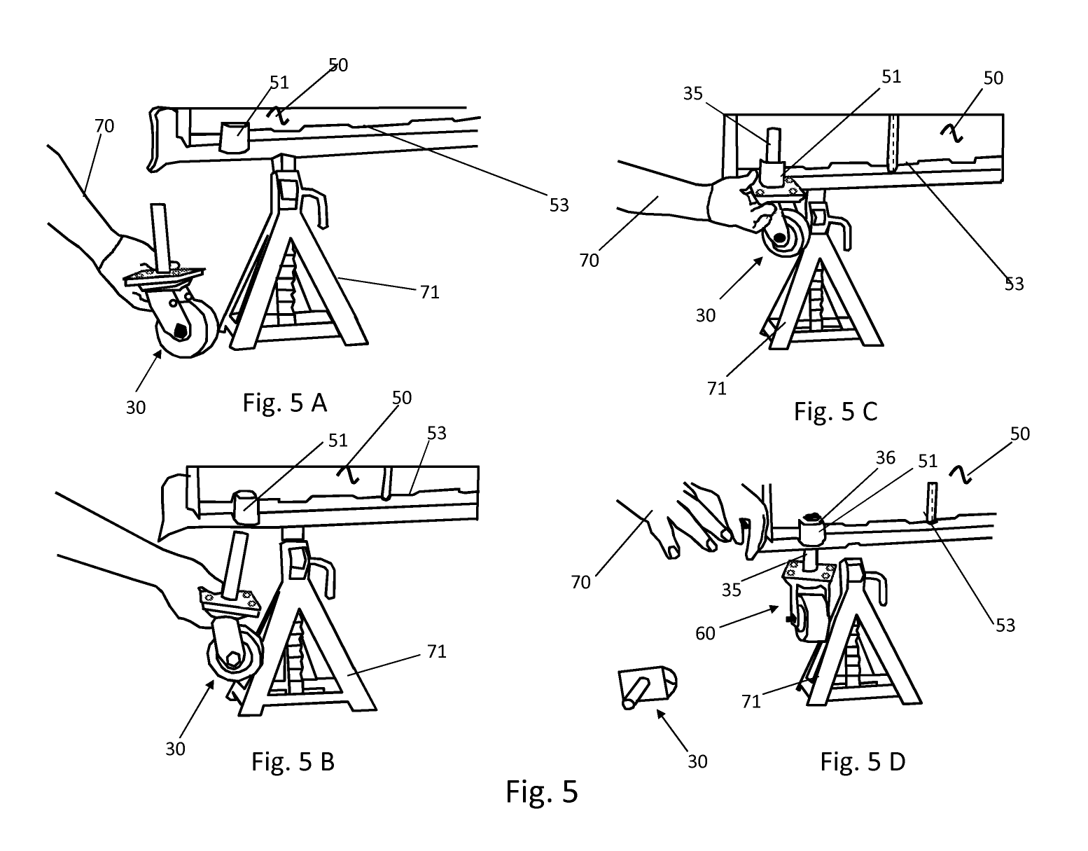

FIGS. 5 A through 5 D are sketches demonstrating how to mount the Port-A-Plow caster to the plow with safety jacks in place.

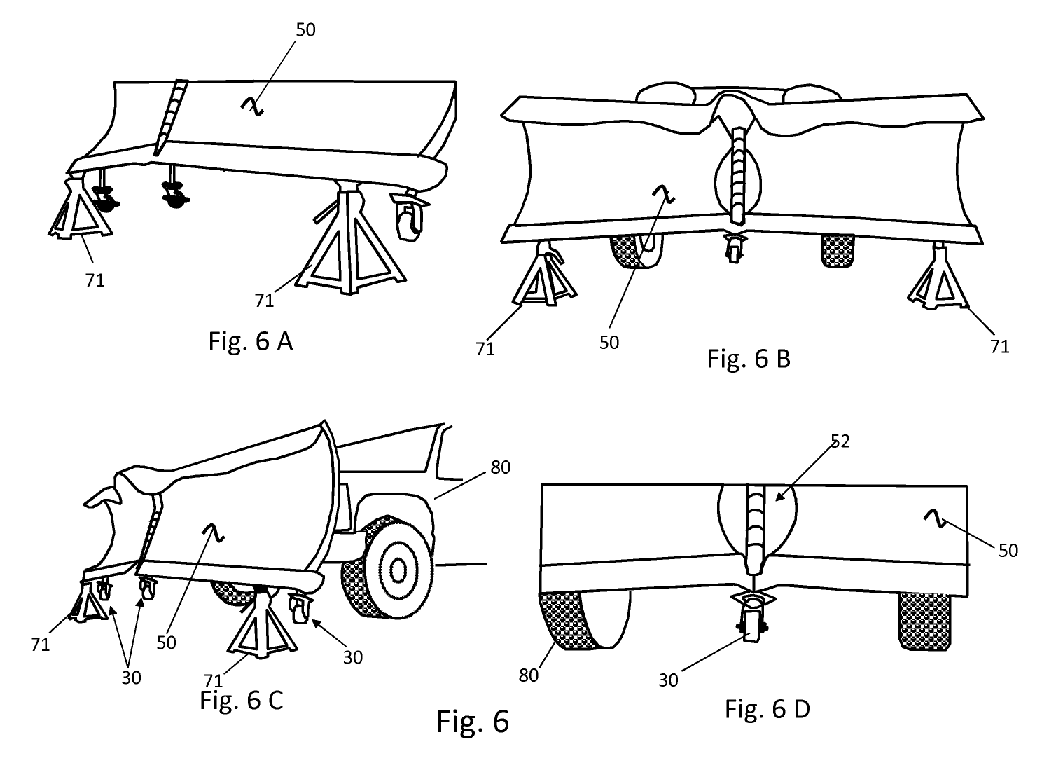

FIGS. 6 A through 6 D are sketches of the Port-A-Plow caster mounted to the plow and the plow mounted to a truck.

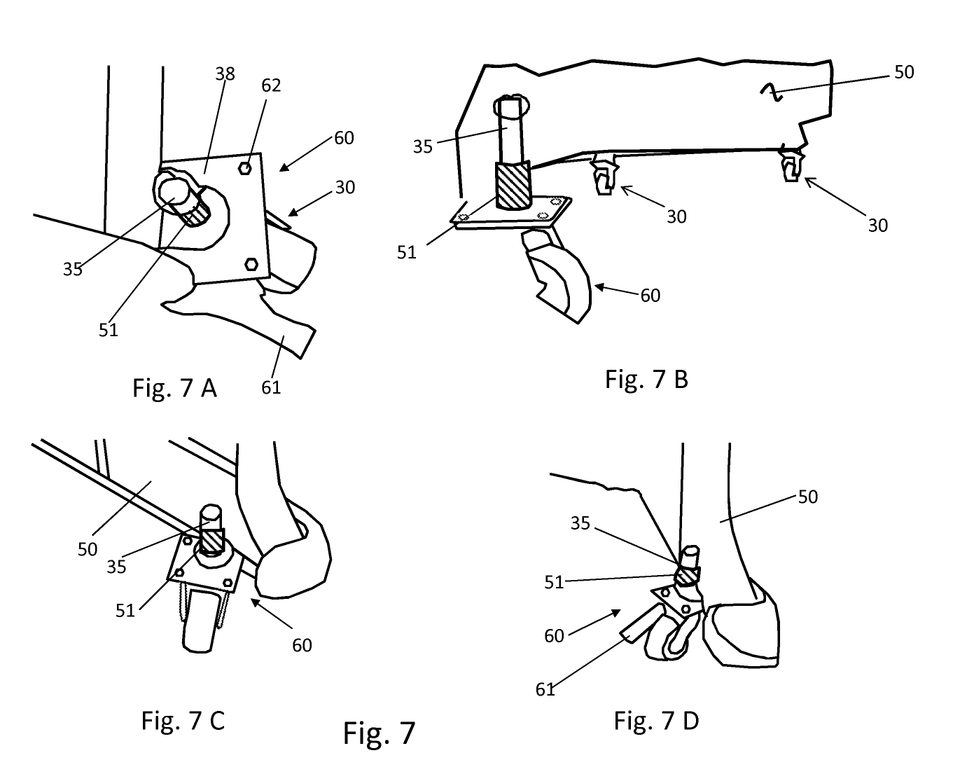

FIGS. 7 A through 7 D are close-up views of the Port-A-Plow caster mounted to a plow.

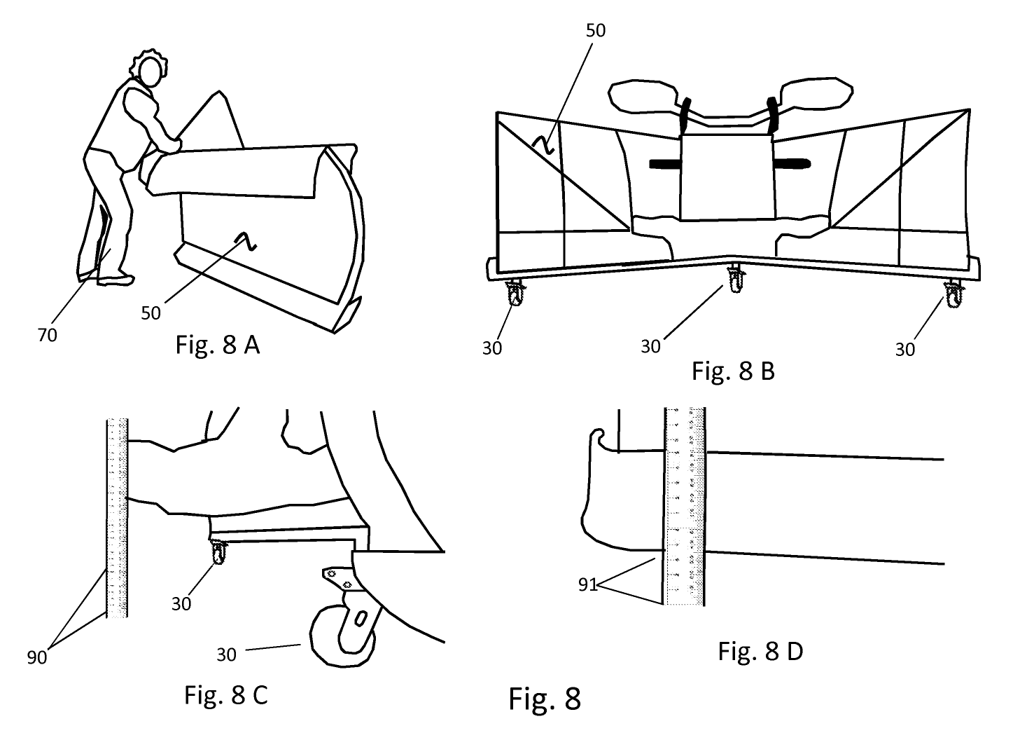

FIGS. 8 A through 8 D are views of the Port-A-Plow caster mounted to a plow and being moved into place with an incline to fit easily to the truck power lift.

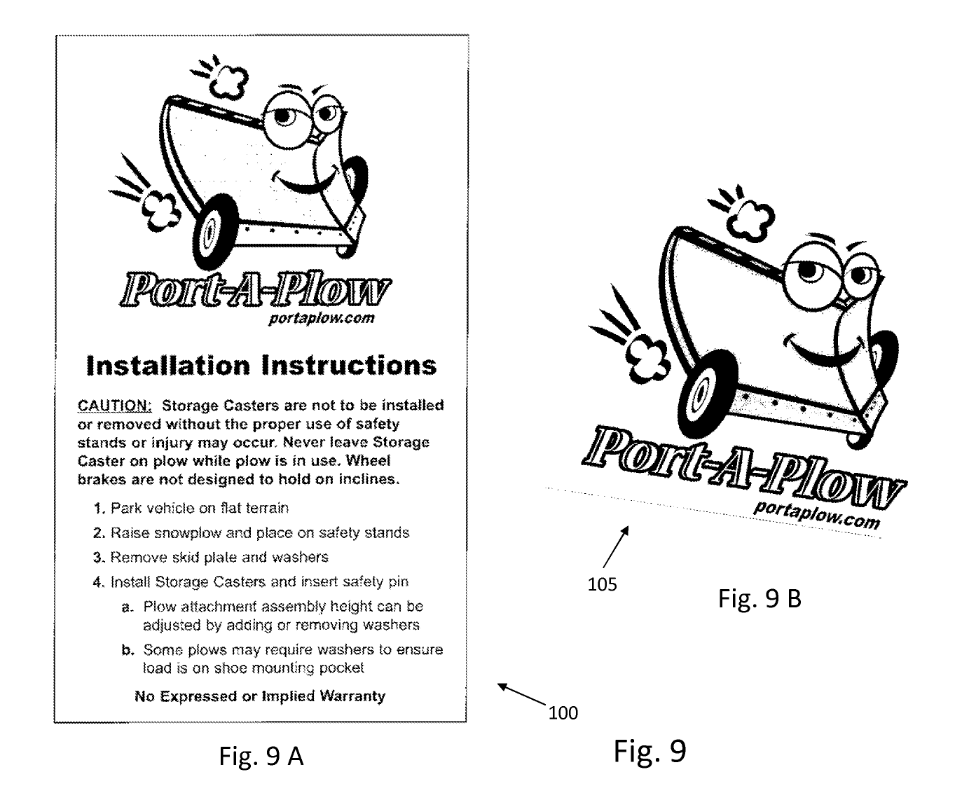

FIGS. 9 A and 9 B are the mounting instructions and logo for the Port-A-Plow caster devices.

### DESCRIPTION OF THE DRAWINGS

### Reference Numerals

The following list refers to the drawings:

TABLE B
Reference numbers

| Item | Objective |
|---|---|
| 30 | General Port A Plow Caster Device |
| 30A | General Caster without Brake |
| 31 | Plow on Jack for Mounting Device |
| 34 | Mounting Aperture |
| 35 | Vertical Shaft |
| 36 | Retainer Means (Pin or Equal) |
| 37 | Shaft Aperture |
| 38 | Base Plate |
| 39 | Securement Means of Shaft to Base plate |
| | (Weld or Equal) |
| 41 | Spacer Washer (Skid Plates & Coaster Device) |
| | or a means for adjusting the height |
| 50 | Snow Plow |
| 51 | Skid Plate Mounting (Loops) Pockets |
| 52 | Vee-Plate |
| 53 | Plow structural member |
| 60 | Caster |
| 61 | Brake |
| 62 | Securing means for Securing (Fastener or Equal) |
| 63 | Caster Mount Plate |
| 64 | Aperture in Mount Plate |
| 65 | Wheel |
| 70 | Operator |
| 71 | Support Jack |
| 80 | Truck or Plow Moving Device |
| 90 | Higher Clearance |
| 91 | Lower Clearance |
| 100 | Installation Instructions |
| 105 | Logo Port a Plow |

### DETAILED DESCRIPTION OF PREFERRED EMBODIMENT

The present development is a Port-A-Plow caster device to facilitate snowplow installation and storage. Particularly this invention relates generally to the field of snow plow carts and dollies. More specifically, the invention is directed to an improved snow plow mover device employing a simple yet sturdy set of caster devices that securely retains a snow plow thereon.

Taught here are the ways a device to store and move snow plows may be placed safely and securely onto a plow of a light and medium duty truck. This may be as an original equipment option with the snowplows at initial sale or an add-on system sold in the equipment aftermarket.

The advantages for the Port-A-Plow caster device 30 to facilitate snowplow installation and storage are listed above in the introduction. Succinctly the benefits are that the device:
1. Provides a lightweight snowplow dolly to be quickly and easily assembled, dis-assembled, lifted and moved by an average individual.
2. May be attached to most snowplows without welding or significant metal fabricating
3. Provides a snow blade mount and lift assembly for a vehicle that is easily attachable and removable from the vehicle
4. Is durable and reliable
5. Is a safe and secure means to move a snowplow
6. Provides a compact, lightweight and portable device
7. Provides a low cost, easy to manufacture snow plow dolly having a low center of gravity
8. May be Marketed to professional snow removers for easy installation and storage of snow plows.
9. Has Economical pricing for independent snow removal persons
10. May use existing process and manufacturing equipment so that there are relatively low start-up costs to manufacture
11. Has a good cost to price ratio for business sensibility
12. Can be sold retail or wholesale
13. May be sold via internet sales

The preferred embodiment of the Port-A-Plow caster device is comprised of a set of at least three special and durable casters each with a vertical shaft and other distinct features; and a means to removably secure each of the casters to the snowplow. The device wheels may be of durable plastic, urethane, neoprene or other composite materials. The rest of the structure is of metal or high durability composite materials.

There is shown in FIGS. 1-9 a complete description and operative embodiment of the Port-A-Plow caster device to facilitate snowplow installation and storage. In the drawings and illustrations, one notes well that the FIGS. 1-4 and FIG. 7 demonstrate the general configuration and use of this product. The operation and use are shown in FIG. 1 and FIGS. 5 through 9 and described in the Operation Section, below.

The accompanying drawings, which are incorporated in and constitute a part of this specification, illustrate an embodiment of the Port-A-Plow caster device 30 for snowplows that is preferred. The drawings together with the summary description given above and a detailed description given below serve to explain the principles of the Port-A-Plow caster device 30. It is understood, however, that the Port-A-Plow caster device 30 is not limited to only the precise arrangements and instrumentalities shown. Other examples of snowplow storage and moving devices are still understood by one skilled in the art of storage and moving devices to be within the scope and spirit shown here.

FIGS. 1A through 1 C are sketches of the Port-A-Plow caster; installation on the plow blade and general moving of the blade on the casters. The casters are described further in detail in FIGS. 2, 3, 4, and 7 below. The installation and moving is included in the Operation Section below.

FIGS. 2 A through 2 H are sketches of the Port-A-Plow caster device 30 with components and features noted. FIG. 2 A show the main components including the caster 60 with the optional brake lever mechanism 65. The vertical shaft 35 and the means to removably retain 36 such as a swivel pin or equal are shown. FIG. 2 C shows further the means for retaining 36 as a swivel pin through the aperture 37 in the solid shaft 35. The shaft 35 is shown as a solid steel shaft but one skilled in structures such as these realizes the shaft could be of various durable materials, various shapes and could be hollow or solid. The preferred embodiment is a solid steel shaft 35 which is later painted as part of the assembly. The shaft 35 is attached securely by a means 39 to a base plate 38. The said base plate 38 has apertures 34 for assembly purposes. FIG. 2 B shows a side view of the Port-A-Plow caster device 30 and the caster mount plate 63. The plate 63 has the securing means 62 (such as a threaded fastener like a nut and bolt or equal) inserted into the baseplate 38 aperture 34 and caster plate 63 aperture 64 for removably securing the top of the caster plate 63 contiguously to the base plate 38 with the vertical shaft 35. FIG. 2 D displays the top of the caster plate 63 with the mounting apertures 64. FIG. 2 E shows the bottom of the base plate 38 with the mounting apertures 34 and the means for securing 39 the base plate 38 to the vertical shaft 35 (not shown here). The means 39 is by welding or otherwise attaching fixedly the vertical shaft 35 to the base plate 38. FIG. 2 F shows the base plate 38 and the shaft 35 securely attached with the plate 38 essentially horizontal and the shaft 35 essentially perpendicular and vertical to the shaft 35. The FIG. 2 G shows the top of the shaft 35 and plate 38 subassembly with the mounting means 36 through the shaft aperture 37 in order to removably attach each caster device 30 to the snowplow 50 (not shown). FIG. 2 H demonstrates an example of a securing means 62 such as a threaded fastener or the like. One skilled in the art of mechanisms like shown here appreciates the plethora of fasteners and components that will substitute for the means to removable attach plate 34 and plate 63 contiguously together.

FIGS. 3 A through 3 C are sketches of a prototype sample of the Port-A-Plow caster 30 with the components and features shown from generally a side and end view. In addition to the components described in FIG. 2, one may see the brake lever 61 and the wheel 65. Notable the wheel 65 may be made of various composite materials and metals. The preferred embodiment is a neoprene plastic that performs very well in sub-zero temperature ranges. The overall metal structural components anticipate some protective mechanism such as, but not limited to, zinc or chrome plating, painting, powder coat, or a thin plastic facing. All to inhibit corrosion and increase overall component life.

FIGS. 4 A through 4 F are more sketches of a prototype sample of the Port-A-Plow caster 30 and components from various views. The components have been described above but these additional views permit a better understanding of the components and the structure of the overall device 30. Also, one should note FIG. 4 D which indicates that the preferred embodiment of the Port-A-Plow caster device 30 is comprised of at least three or more caster devices. This permits the assembly to the snowplow 50 to create a virtual planar support which balances the snowplow 50 when it is being moved.

FIGS. 7 A through 7 D are close-up views of the Port-A-Plow caster 30 mounted to a snowplow 50. All views show the device 30 in place where the vertical shaft 35 has been placed interior to the skid plate mounting loops 51 which are integral to the plow 50. Once each vertical shaft 35 is extended through the pocket loop 51, the removable securement means 36 is placed through each individual apertures 37 and the individual caster device 30 is secured removable to the snowplow 50. As shown in the FIGS. 7 A through 7 D, the plow 50 and loop 51 is then supported by the top of the plate 38 at each caste device 30.

FIG. 5 through FIG. 9 are sketches of uses and are described below.

The details mentioned here are exemplary and not limiting. Other specific components and manners specific to describing the Port-A-Plow caster device 30 may be added as a person having ordinary skill in the field of storage and moving devices and their uses well appreciates.

### OPERATION OF THE PREFERRED EMBODIMENT

The Port-A-Plow caster device 30 to facilitate plow installation and storage has been described in the above embodiment. The manner of how the device operates is described below. One notes well that the description above and the operation described here must be taken together to fully illustrate the concept of the Port-A-Plow caster device 30.

The preferred embodiment of the Port-A-Plow caster device 30 is comprised of a set of at least three special and durable casters each with a vertical shaft and other distinct features; and a means to removably secure each of the casters to the snowplow. The device wheels may be, for example and not as a limitation, made of durable plastic, urethane, neoprene or other composite materials. The rest of the structure is of metal or high durability composite materials.

The Port-A-Plow caster device 30 operates as shown in the various figures and drawings described below. FIGS. 1 B and 1C are sketches of the Port-A-Plow caster being installed on the jack stands and then moved by an operator.

FIGS. 5 A through 5 D are sketches demonstrating how to mount the Port-A-Plow caster 30 to the snowplow 50 with safety jacks 71 in place. All FIGS. 5 A through 5 D show the consecutive steps. The snowplow 50 is placed securely on the safety stands 71. Next, the device 30 with the vertical shaft 35 is placed with the shaft 35 interiorly through the skid plate mounting loops 51 which are integral to the plow 50. Once each vertical shaft 35 is extended through the pocket loop 51, the removable securement means 36 is placed through each individual aperture 37 and the individual caster device 30 is secured removable to the snowplow 50. One skilled in the art of structural members understands that the plow structural member 53 permits the three or more casters 30 to be laterally stabilized in the assembly.

FIGS. 6 A through 6 D are sketches of the Port-A-Plow caster 30 mounted to the snowplow 50 and the plow 50 mounted to a truck 80. One sees from the various angles how the plow 50 is fitted with the device 30. One should note the device 30 mounted at the bottom of the extended vee 52 in order to balance the load of the plow 50 onto the casters 30, collectively, in a plane-like configuration. This adds to the stability of the combination of the Port-A-Plow caster device 30 and snowplow 50 combined assembly.

FIGS. 7 A through 7 D are additional close-up views of the Port-A-Plow caster 30 mounted to a snow plow 50. All the components have been explained, above.

FIGS. 8 A through 8 D are views of the Port-A-Plow caster mounted to a plow and being moved into place with an incline to fit easily to the truck power lift. FIG. 8 A shows the operation 70 easily moving the snowplow 50 once the Port-A-Plow caster devices 30 are added. FIG. 8 B shows the full plow 50 on the three (3) casters 30. FIG. 8 C shows the attachment device for the snowplow 50 to mount to the vehicle 80. The height of this is controlled by the number of spacer washers used on the casters 30 between the top plate 38 and the loops 51. The more incline (high clearance 90) required, the more washers placed on the vertical shaft 35 at the two ends of the plow (opposite the vee 52). FIG. 8 D shows the vee plate 52 with a single washer to keep the clearance low 91.

FIGS. 9 A and 9 B are the mounting instructions and logo for the Port-A-Plow caster devices. Storage Casters are not to be installed or removed without the proper use of safety stands or injury may occur. Never leave Storage Caster on plow while plow is in use. Wheel brakes are not designed to hold on inclines. FIG. 9 A describes the steps as:

| ITEM | Installation Step |
|---|---|
| 1 | Park vehicle on flat terrain |
| 2 | Raise snowplow and place on safety stands |
| 3 | Remove skid plate and washers |
| 4 | Install Storage Casters and insert safety pin |
| 4A | Plow attachment assembly height can be adjusted |
| | by adding or removing washers |
| 4B | Some plows may require washers to ensure load is |
| | on shoe mounting pocket |

FIG. 9 B shows the logo of the Port-A-Plow caster device.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

With this description it is to be understood that the Port-A-Plow caster device 30 is not to be limited to only the disclosed embodiment of product. The features of the device 30 are intended to cover various modifications and equivalent arrangements included within the spirit and scope of the description.

What is claimed is:

1. A Port-A-Plow caster device for moving and storing a snow plow, the device is comprised of:
(a) at least three caster wheels made of durable material, each caster with a vertical shaft that has a removable securement means and other distinct mechanical features; and
(b) a means to removably secure each of the casters to the snowplow
wherein the snowplow is placed on a set of safety stands to enable the casters to be secured to the plow in a set of shoe mounting pockets and to enable a means for adjusting the plow height (washers) to be added to adjust the assembly height for different heights on various vehicles.

2. The device according to claim 1 wherein the durable material for the wheels is from the group consisting of durable plastic, urethane, neoprene, composite materials, metal, steel, aluminum, and cast iron.

3. The device according to claim 1 wherein the steel shaft is solid.

4. The device according to claim 1 wherein the steel shaft is a hollow tube.

5. The device according to claim 1 wherein one or more of the caster wheels has an optional brake lever mechanism.

6. The device according to claim 1 wherein the means to adjust the height is at least one spacer washer.

7. The device according to claim 1 wherein the removable securement means for the vertical shaft is a swivel pin that may be placed through an aperture at the top of the shaft.

8. A Port-A-Plow caster device for moving and storing a snow plow, the device is comprised of:
(a) at least three caster wheels, the wheels made of neoprene plastic material, each caster having a mount plate with a means for securing the wheel to a baseplate and a vertical shaft with an aperture for a swivel pin, said shaft secured contiguously to the base plate;
(b) the removable swivel pin for each caster serving as a means to removably secure each of the casters to the snowplow
wherein the snowplow is placed on a set of safety stands to enable the casters to be secured to the plow in a set of shoe mounting pockets and to enable a set of at least one washer that serves as a means for adjusting the plow height added as needed to adjust the assembly height of the snowplow attached to the casters to the device for different heights on various vehicles.
